(19) United States
(12) Patent Application Publication
(10) Pub. No.: US 2015/0338248 A1
(43) Pub. Date: Nov. 26, 2015

(54) AN OPTICAL FIBER-BASED FORCE TRANSDUCER FOR MICROSCALE SAMPLES

(71) Applicants: COUNCIL OF SCIENTIFIC & INDUSTRIAL RESEARCH, New Delhi (IN); RAMAN RESEARCH INSTITUTE, Bangalore (IN)

(72) Inventors: Chirag Deepak KALELKAR, Pune, Maharashtra (IN); Pramod Appukuttan PULLARKAT, Sadashivanagar, Bangalore (IN); Seshagiri RAO, Sadashivanagar, Bangalore (IN); Ashish Kishore LELE, Pune, Maharashtra (IN)

(21) Appl. No.: 14/760,640

(22) PCT Filed: Jan. 13, 2014
(86) PCT No.: PCT/IB2014/058223

§ 371 Date: Jul. 13, 2015

(30) Foreign Application Priority Data
Jan. 11, 2013 (IN) 0086/DEL/2013

(51) Int. Cl. G01D 5/26; G01Q 60/24

(52) U.S. Cl. CPC G01D 5/268; G01Q 60/24

(57) ABSTRACT

The present invention relates to an etched optical fiber as force transducer with feedback control, with a force range of 1-108 pN and a displacement range of 10-105 nm with a spatial resolution of the order of tens of nanometers are accessible with the instrument. The sample deformation (evolution) can be imaged simultaneously with rheological measurements. The device is used to perform extension rheology of polymer melts, silk, or other bio-fluids at microscales, measure mechanical responses of living cells such as neurons, muscle cells, etc. It is also used as a passive probe for microscale force measurements and to investigate properties of active suspensions such as bacterial baths.

### FIELD OF THE INVENTION

The present invention relates to a measuring device of force transducer based on optical fiber. The present invention particularly relates to a device with independent strain control for microscale samples. The invention specifically relates to a miniature and sensitive, easy to calibrate measuring device capable of independently measuring force in the range of 10⁻⁴ N to 10⁻¹² N and displacement with sensitivity in the range of 0.04 μm to 0.01 μm.

### BACKGROUND OF THE INVENTION

Single-molecule force spectroscopy has emerged as a powerful tool to investigate the forces and motions associated with biological molecules and enzymatic activity. The most common force spectroscopy techniques are optical tweezers, magnetic tweezers and atomic force microscopy (AFM). Force spectroscopy is used as a tool to characterize ligand and antibody binding and has been extended to study the complex unfolding of single proteins and nucleic-acid structures. Force spectroscopy in turn spurred the development of, and benefited greatly from, theoretical approaches that permit the extraction of detailed equilibrium thermodynamic parameters from inherently non-equilibrium pulling experiments. All these techniques have been widely used and are constantly being updated. Considering the fact that a skilled person can appreciate the basics of these techniques, we discuss the limitation of these techniques which prompted the current invention.

The versatility and precision afforded by optical tweezers are limited by the requirement of a pure and homogenous sample. Essentially, any dielectric particle near the focus of the trapping laser will be trapped, and the number of particles that can be simultaneously trapped can be quite large. In optical tweezers, the problem of local heating also occurs, which is said to affect the enzymatic activity and the local viscosity of the sample.

Unlike optical tweezers and atomic-force microscopy, the magnet assembly of magnetic tweezers cannot be manipulated. Furthermore, the bandwidth and sensitivity are limited by the video-based detection used, which prevents direct measurement of very fast or very small displacements. Electromagnetic tweezers permit full three-dimensional manipulation, but this requires cumbersome feedback-control techniques in addition to custom-machined pole pieces, and this technique has not yet achieved the sensitivity of other force spectroscopy techniques.

AFM is the most sophisticated of the three techniques, however a major drawback of AFM is the large size and relatively high stiffness of the cantilevers used, which imposes a lower bound on the available force range and a reduced bandwidth, particularly under aqueous conditions. The forces associated with many biological processes are therefore difficult to study with AFM. Specificity is a second major concern in many AFM pulling experiments. It can be difficult to discriminate interactions of the AFM tip with the molecule of interest from nonspecific interactions/inappropriate contacts with the molecule of interest, such as binding at an intermediate position rather than at one of the ends.

Several attempts are being made by researchers across the globe to improve these techniques and come up with a sensitive and specific method to ascertain the rheological properties of substances.

Reference is made to Karel Svoboda, et. al in Annu. Rev. Biophys. Biomol. Strct. 1994. 23:247-85 have reported technical issues, including a critique of optical trapping theory, considerations for instrument design and calibration, and novel approaches for measuring forces on biological samples.

Further reference is made to Dufor, et. al in Journal of Sensors Volume 2012, Article ID 719898, have reported the use of a silicon microcantilever for measuring the viscoelastic properties of complex fluids. However, the method proposed has the limitation that the fluid density should be known, and that an accurate value of the static deflection has to be extracted from the spectrum measurement.

Another reference is made to Shelley L. Anna, et. al in J. Rheol. 45(1), January/February 2001 have compared results from several filament-stretching extensional rheometers (FiSER) and established that filament stretching rheometry has matured into a reliable method for measuring the response of viscoelastic fluids, particularly dilute polymer solutions, to a nearly ideal uniaxial extensional deformation. The kinematics of the flow effectively isolates extensional effects from those of shearing. The group opines that filament stretching rheometry has the potential of providing useful information for the development of constitutive equations. However, this technique has the major disadvantage of large size and limited force-range measurable. Also, the instruments cannot function in constant force or constant strain modes and require large amounts of sample. The FiSER is not commercially available, and substantial expertise is required for repairing and maintaining the instrument.

A commercially available variant of the instrument is the Capillary Breakup Extension Rheometer (CaBER, Thermo-Scientific, United States). This is an easy-to-use instrument for quantifying the rheological response of a polymeric liquid/melt subject to an extensional deformation. This instrument can be used to quantify the extensional viscosity, the polymer relaxation time, and the breakup time of filaments formed in an extensional flow. However, large sample sizes are required and the force range measurable is restricted. The device is relatively large in size and not easily portable or individual parts replaceable.

Yet another reference is made to Cluzel etal in Science Vol 271, 1996 have measured displacement response of single duplex molecule to force of 10-160 pN and shown promising results but in DNA samples alone.

Hence the available instruments/apparatuses/devices to measure rheological properties of materials available currently had one or other disadvantages like calibration procedure is difficult, sample required was too much, device was robust and resource intensive, limited force calculation, usable only for biological materials that too with compromised efficiencies. However inventors have addressed this long standing problem of the prior art and came up with a device which had a. Easy calibration procedure. b. with an optional feedback control, c. being also usable for living cells, d. calculate several orders of magnitudes in force, e. portable f easy to install and use, higher sensitivity and efficiency g. capability to work on microscale.

### OBJECTIVES OF THE INVENTION

The main objective of the present invention is to provide a device of force transducer based on optical-fiber which obviated the draw backs of the hitherto known prior art as detailed above.

Another objective of the present invention is to provide a device to track deformation of the sample.

Yet another objective of the present invention is to provide a device which is capable of independently measuring force in the range 10⁻⁴N to 10⁻¹²N.

Still another objective of the present invention is to provide a device which is easy to calibrate.

Still another objective of the present invention is to provide a device which measures displacement with sensitivity in the range of 0.04 to 0.01 μm.

Yet another objective of the present invention is to provide a device which uses an etched optical fiber as a force sensing cantilever.

Yet another objective of the present invention is to provide a device for independent control of the extensional strain and measurement of an extensional force (or tensile stress) on a sample.

Still another objective of the present invention is to provide a device which provides temporal resolution in the range 10⁻⁵ s to 10⁻⁷ s using a Quadrant Photodiode.

Still another objective of the present invention is to provide a device to impose an extensional strain and measure the tensile stress on a sample, wherein the sample may be biofluids such as blood, saliva, silk suspension, etc. where small quantities of sample are available.

Yet another objective of the present invention is to provide a device for that detects Brownian motion in a bacterial suspension.

Yet another objective of the present invention is to provide a device in which extensions of the order of 10⁻⁸ m to 10⁻⁴ m can be imposed with a spatial resolution in the range of 8 nm to 12 nm.

Still another objective of the present invention is to provide a device which allows different modes of operation such as step-force, step-strain, or a specific force or strain protocol. Still another objective of the present invention is to provide a device which is used for simultaneous video microscopy with sub-micron resolution can be performed using phase-contrast or fluorescence modes of observation.

Yet another objective of the present invention is to provide a device which calculates the rheological properties of a sample in a table-top.

Yet another objective of the present invention is to provide a device which uses parts which are interchanged as per need.

Still another objective of the present invention is to provide a device which calculates the rheological properties of a sample for quantities in the range of 0.5 to 2 microliters.

Still another objective of the present invention is to provide a device which is used to carry out oscillatory extensional rheometry, and calculates rheological quantities of interest which can be compared with analogous results from oscillatory shear rheometry experiments.

Yet another objective of the present invention is to provide a device which calculates the rheological properties of living cells such as bacteria, muscle cells, neurons and biofluids such as blood, saliva, silkworm and spider silk, etc.

### SUMMARY OF THE INVENTION

Accordingly the present invention provides a measuring device with an etched optical fiber as a force sensing cantilever(3) and Quadrant Photodiode (QPD) capable of independently measuring force in the range from 10⁻⁴N to10⁻¹²N and displacement with sensitivity in the range of 0.04 μm to 0.01 μm, using a feed-back loop.

In another embodiment of the present invention, sample (4) is placed between a cantilever (3) and a piezoelectric transducer (6)

In yet another embodiment of the present invention, a piezoelectric transducer (6) and an optical fiber(2) are coupled to a laser(1) which is placed above the objective of a microscope(5).

In yet another embodiment of the present invention, cantilever (3) made out of optical fiber(2) by etching for sensing force.

In still another embodiment of the present invention, Position-Sensitive Detector (9) tracks the motion or deflection of the optical fiber cantilever (3).

In still another embodiment of the present invention, a lamp (13) within the microscope which illuminates the sample (4) through a condenser (7) using green light.

In yet another embodiment of the present invention, camera (10) mounted on a side port of the microscope (5) which records image

In yet another embodiment of the present invention, filters (8) are placed in front of the camera (10) and the Position-Sensitive Detector (9) which separates the green illumination light and the red laser light.

In still another embodiment of the present invention computer interface (14) records Position-Sensitive Detector (9) and piezo control (11) reading.

In still another embodiment of the present invention, custom-made software records and analyzes captured images in the computer (14).

In yet another embodiment of the present invention, sample (4) is placed between cantilever (3) and syringe needle (15).

In yet another embodiment of the present invention, syringe needle (15) is connected to the piezo transducer (6).

In still another embodiment of the present invention, linear polarizer and Fiber-optic connector (16) control laser intensity and couples laser light to the said optical fiber (2)

In still another embodiment of the present invention, beam splitter (12) splits the laser light.

### BRIEF DESCRIPTION OF THE DRAWINGS

FIG. 1: (a) Schematic diagram of the Micro-Extensional Rheometer (MER), mounted on a vibration-isolation table. (b) A close-up view of the working area of the MER. FIG. 1(c): Calibration of QPD output against the Piezo actuator

FIG. 2: (a) Etched fiber of diameter ˜8.5 μm. (b) Unetched fiber of diameter ˜124 μm. 2(c) Schematic of split fiber unit for easy handling of optical fiber 2(d) Schematic of device to etch multiple fiber.

FIG. 3: The setup used for testing simple harmonic motion of the fiber tip.

FIG. 4: (a) Plot of the resonance frequency ᵣ as a function of the amplitude of oscillation ₀ of the fiber tip. The image of the fiber tip at resonance is shown in the inset. (b) Plot of ᵣ as a function of d/l², where d is the diameter of the fiber and l is its length.

FIG. 5: Plot of the root-mean-square centroid displacement (Δx_{cm}) RMS of a rigidly mounted unetched fiber, recorded using a camera as a function of the total magnification Mₒ.

FIG. 6: Plot of the centroid x_{cm}, coordinate of the fiber tip recorded by the PSD as a function of the x_{cm}, coordinate calculated from the camera images.

FIG. 7: Plot of the centroid y_{cm}, coordinate of the bead attached to the piezo, calculated from camera images as a function of the commanded piezo displacement, in steps of (a) 0.1 μm and (b) 0.01 μm.

FIG. 8: (a) Plot of the normalized centroid displacements Δx_{cm}, and Δy_{cm} of the etched fiber recorded using the camera, with the tip immersed in (a) tryptone medium (b) tryptone medium containing E. coli bacteria.

FIG. 9: A filament of polydimethylsiloxane (PDMS) between two flat surfaces. The (defocused) laser spot exiting the fiber tip can be seen at the bottom of the image.

### DETAILED DESCRIPTION OF THE INVENTION

In accordance with the objects of the current invention which overcomes the aforesaid problems of prior art. The device used as Micro-Extensional Rheometer (MER) which uses an etched optical fiber as a force sensing cantilever and is easy to calibrate.

The device according to the invention has a force range of 1-10⁸ pN and a displacement range of 10-10⁵ nm with a spatial resolution of the order of tens of nanometers are accessible with the instrument.

The device according to the invention uses a feedback-loop algorithm to control either the extensional strain or the force on the sample.

The device according to the invention, can image the sample deformation (evolution) simultaneously with rheological measurements.

The device in accordance with the present invention its operating principles, calibration procedures, supply details and applications are described further in detail.

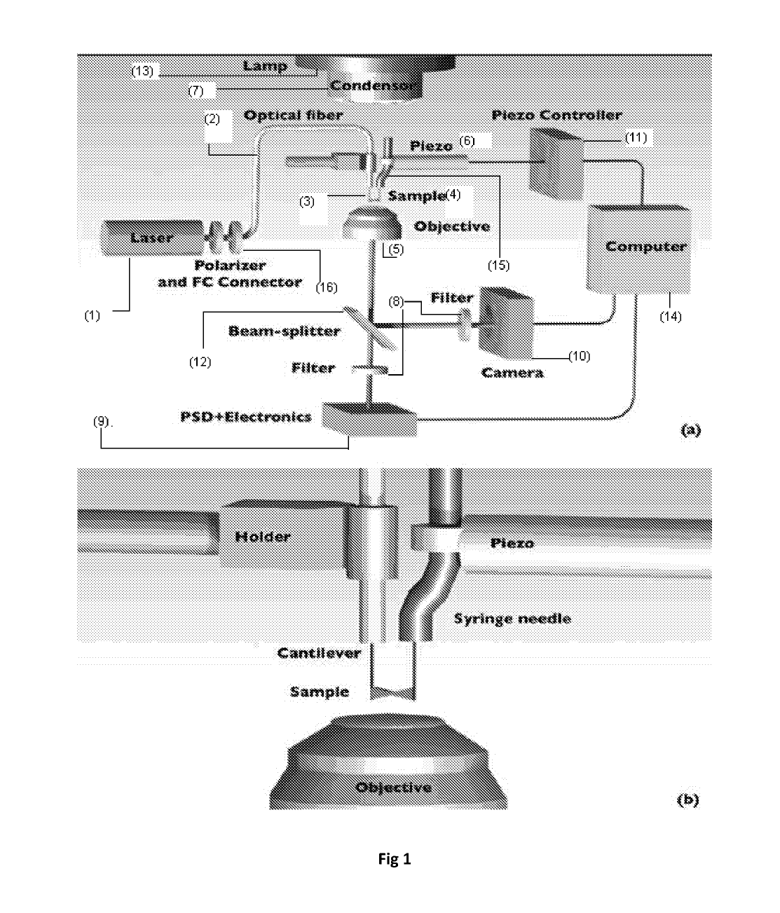

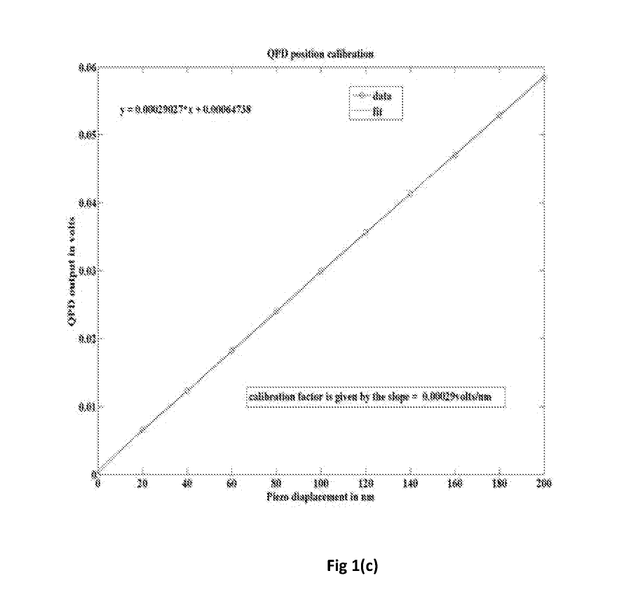

The set-up of the device in accordance with the present invention is illustrated in FIG. 1.

1. Instrumentation:

A schematic diagram of the MER setup is shown in FIG. 1(a), along with a close-up view of the working area in FIG. 1(b).

The working area comprises of a piezoelectric transducer and an optical fiber coupled to a laser, placed above the objective of a microscope. A cylindrical portion of the optical fiber acts as a cantilever for sensing the force. The length and diameter of the cantilever can be adjusted to achieve the desired force sensitivity. The tip of the cantilever is seen as a bright spot through thFe microscope, and a Position-Sensitive Detector (PSD) is used to track its motion or deflection.

In the case of polymer melts, a picoliter-volume of the sample is placed within the gap between the tip of the cantilever and the end of a syringe needle (or any other suitable material of appropriate dimensions) attached to the piezo, as shown in FIG. 1(b).

A lamp within the microscope is used to illuminate the sample through a condenser using green light, and images are recorded by a camera mounted on a side port of the microscope. Appropriate filters are used in front of the camera and the PSD to separate the green illumination light and the red laser light. The PSD reading and piezo control are obtained using a computer interface. Images are recorded and analyzed using custom-made software.

Following are the details of the set-up used by inventors' particularly. However the advantage with the device is that its use is not limited to some brand or make of attachments to be used and may be integrated with any existing set of instruments.

The setup is mounted on a vibration-isolation table (VH3648W-OPT, Newport Corp., USA). A 17 mW, polarized,TEM00 He—Ne laser (25-LHR-925, CVI Melles-Griot, USA) with a beam diameter of 0.96 mm, operating at an output wavelength of 633 nm was used. The laser intensity is controlled by a linear polarizer (46 575, Edmund Optics, Singapore). The laser light is coupled to the optical fiber using an FC (Fiber-optic Connector) (F240FC-B, Thorlabs Inc., USA).

The single-mode optical fiber (P1-630A-FC, Thorlabs Inc., USA) used has a mode field diameter (core) of 4.3 μm made of germanium-doped silica for a design wavelength of 633 nm, and a fiber outer diameter of 125±1 μm made of silica. The tip of the cantilever as well as the sample are imaged using a microscope (Zeiss Observer.D1, Carl Zeiss GmbH, Germany) with a magnification 40×/0.5. The sample is illuminated by green light using an interference filter placed above the microscope condenser.

A beam-splitter sends 20% of the incident light to a side port mounted with a CCD camera (Andor Luca R604, Andor Technology, Ireland). A red-absorption filter is placed in front of the camera to attenuate the intensity of the laser light incident on it along with the scattered light (green) due to the sample for optimal simultaneous imaging. The CCD camera has a resolution of 1004(H)×1002(V) pixels, a pixel size of (8×8)μm2 and a frame rate of 12.4 Hz. For certain applications, a high-speed camera (MotionPro Y4, Integrated Design Tools Inc., USA) is available as an option. We used a pin-cushion type two-dimensional PSD (S2044, Hamamatsu Photonics, Japan) with an active area of (4.7×4.7)mm2.

The PSD was mounted with the detector surface coinciding with the image plane of the side port of the microscope which collects 80% of the light incident on the objective. A narrow bandpass interference filter (FL632.8-10, Thorlabs Inc., USA) placed in front of the detector allows only the laser light to be incident on the PSD. The PSD signal processing circuit (C9069, Hamamatsu Photonics, Japan) computes the position of the light spot, performs A/D conversion, and sends digital output at 200 Hz through a RS-232 interface to a computer. The PSD gives as output, the signal position and the incident light level in 12-bit hexadecimal format.

A LabVIEW (Ver.11, National Instruments, USA) code was used to record the PSD output and convert from hexadecimal to decimal. This code was tested against the application software of the PSD(Ver. 1.1, Hamamatsu Photonics, Japan).

2. Position Detection with the Device: Position detection can also be performed using a Quadrant Photo-Diode (QPD) (QD-50-0, OSI Optoelectronics, USA) mounted on a side port of the microscope along with a 16-bit Data-Acquisition Card (PXIe-6363, National Instruments, USA).

This device has a limited spatial range, but offers superior temporal resolution with a sampling rate up to 2 MHz. The piezo actuator (P-841.60, Physik Instruments GmbH, Germany) used for applying displacements has a 90 μm travel range, and comes with a single-axis piezo servo-controller (E 625.SR) having 24-bit A/D and 20-bit D/A resolutions. The actuator can sustain a pushing force up to 1000 N and a pulling force up to 50 N. The piezo is controlled using the same LabVIEW code via a serial-port interface. Prior to use, zero-point adjustment of the piezo servo-controller was carried out, as described in the manual and the LabVIEW-control tested against the vendor application software MikroMove (Ver. 2.4.06, Physik Instruments GmbH, Germany). At 40× magnification position resolution ˜1.5 nm spatial range 0.75-1 micron.QPD output is obtained in voltage. It is calibrated against the Piezo actuator and voltage to Position conversion is 0.0003V/nm as depicted in FIG. 1(c). A feedback algorithm is implemented in the LabVIEW code to perform controlled force or controlled strain tests. The software allows the user to select from the following modes of operation: constant strain mode and constant force mode. The user-selected mode is implemented via a feedback-loop algorithm. The user selects the mode of operation and supplies as input, the desired value of the extension (or force), the diameter and length of the cantilever, and the initial filament length after loading the sample and allowing the filament to stabilize. The code implements the desired mode of operation and outputs the calculated spring constant, and the current values of the PSD and piezo positions. A graphical display shows the current values of the force and the strain as a function of the elapsed time. The optical fiber and the piezo are mounted on the microscope stage using two separate sets of three-axis translation stages with micrometer precision from Thorlabs Inc. (USA) and Holmarc Opto-Mechatronics Pvt. Ltd. (India). An aluminium box is used to enclose the parts mounted on the microscope stage to minimize disturbances due to air currents.

3. Preparation of Cantilevers

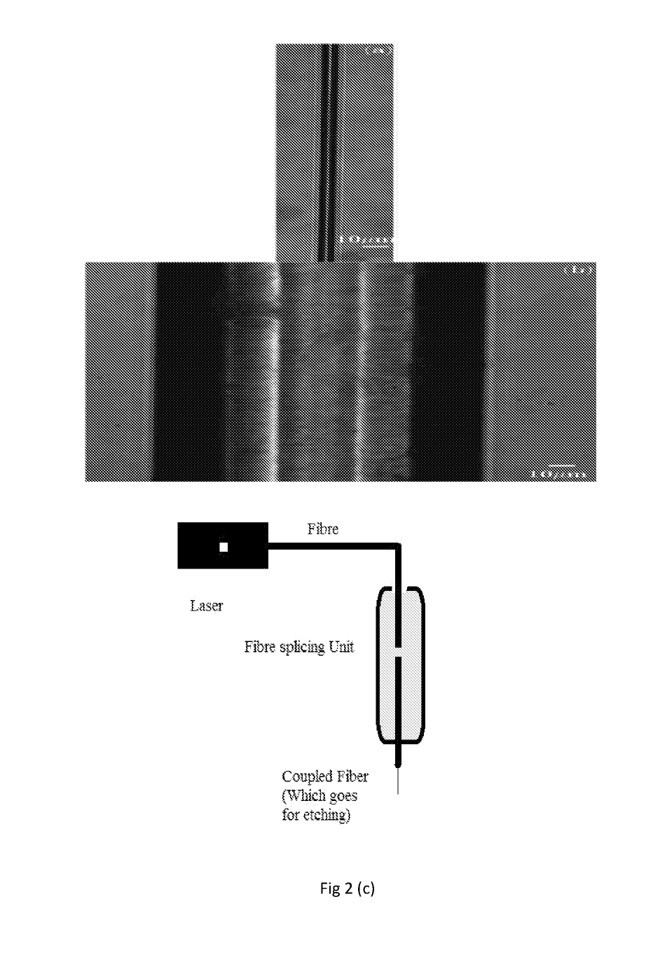

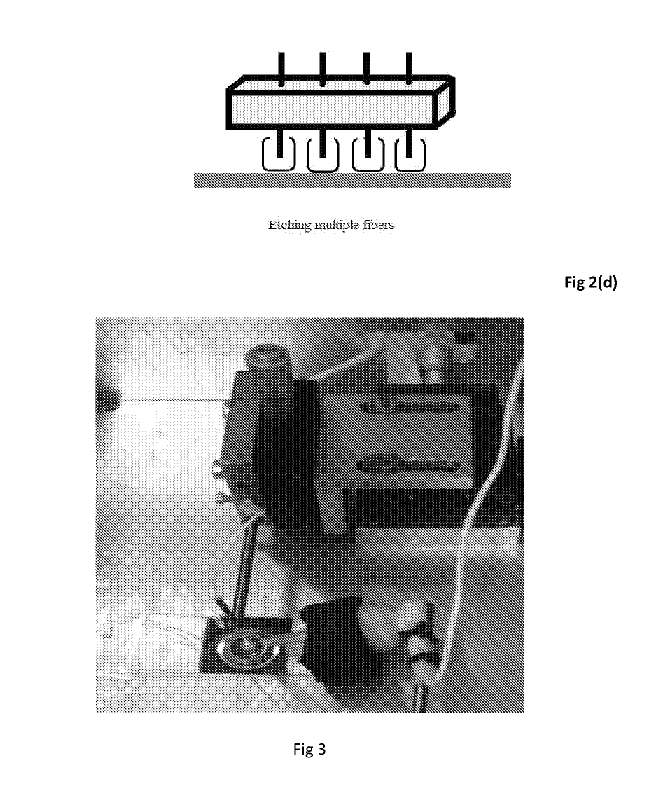

For calibration tests, optical fibers with etched as well as unetched tips were used (see FIGS. 2(a) and 2(b)). The time required for etching the fiber varied with the required diameter and the age of the hydrogen fluoride (HF, Merck, India) solution used. For etching the fiber, the required length of the fiber was dipped into freshly prepared solutions of HF. For example, to obtain an etched fiber with a diameter ˜10 μm, the following concentrations of HF were used in the sequence: 48% for 30 min, 25% for 25 min, and 15% for 15 min, followed by a rinse with de-ionised water. The acid is gently stirred using a magnetic stirrer during the etching process. This method produces nearly uniform cylindrical cantilevers with a taper which is less than 1 μm over a length of 15 mm.

After etching, the tip is cut using a scalpel to obtain a nearly circular aperture (confirmed by observing the profile of the emergent light). The length of the fiber is measured under a stereo-microscope using a Vernier calliper with a least count of 20 μm and the diameter is measured using the microscope and the CCD camera, with accuracy better than a micron. Handling of the optical fiber is made easy and user friendly by splitting the fiber unit into two sections. The first section connected to Laser remains untouched in this new scheme and a small portion of fiber is taken for etching and is coupled to the other section.

Following steps involved in coupling the fibers are:

Preparation of bare fibre: Protective coating, sheaths and jackets are removed leaving only bare fiber showing on both sides. Fiber ends are positioned together inside the mechanical splice unit. The splicing unit contains an index matching gel that helps couple the light from one fiber end to the other.

The splicing unit used by the inventors for the process is Model:TS126 -Ø125 μm to Ø140 μM and MM Mechanical Fiber-to-Fiber Splice (Thorlabs USA).This way one needs to handle only the tail piece to be coupled. One can easily stock many such add on pieces and keep replacing the fresh ones on the setup as per the requirement as in FIG. 2(c),Inventors have also devised a unit for etching many fibers simultaneously. Short pieces of bare fiber (without cladding) are mounted on to a holding block and etched simultaneously to fabricate several cantilevers with similar force constant (FIG. 2(c)). The etched pieces can then be coupled to the main fiber which feeds the laser light using a fiber coupling unit. This unit has a holder with multiple sections to hold the fiber pieces and all of them can be etched at the same time using a set of stirrers as in FIG. 2(d).

4. Calibration and Linearity Test of the Cantilever

The resonance frequency of the cantilever in air was measured by exciting it using sound waves. The waves emanating from an earphone speaker were concentrated onto the tip of the cantilever using a conical tube, as shown in FIG. 3. The speaker was excited using a sinusoidal signal from a function generator (33220A, Agilent Corp., USA).

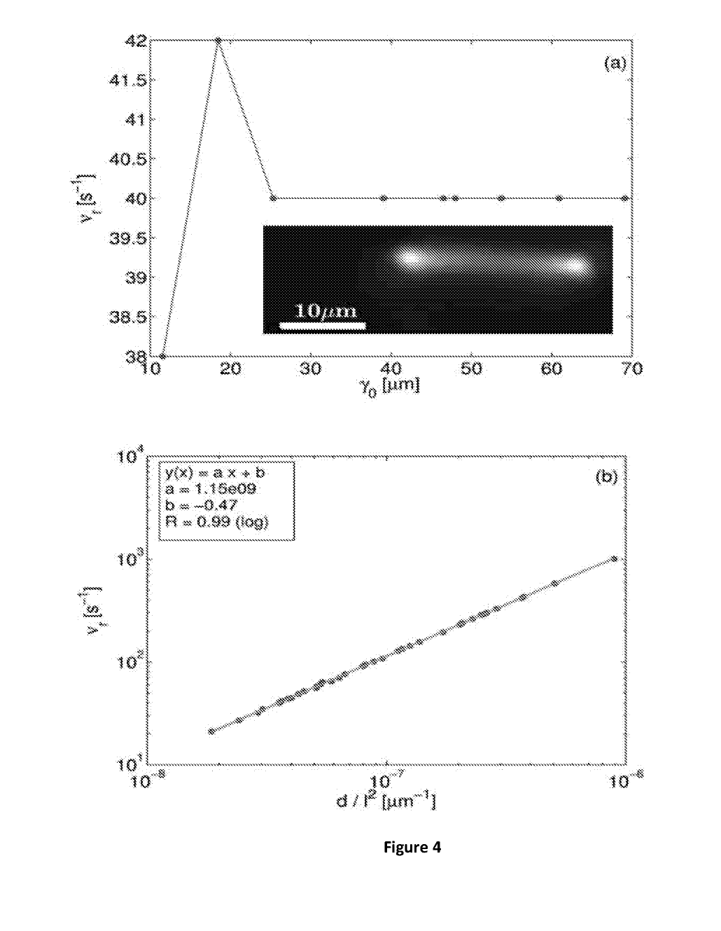

The aperture of the fiber was imaged using the CCD camera. The time period of oscillation is much smaller than the exposure time chosen for the camera, which produces “dumbell”-shaped intensity patterns in the recorded images (FIG. 4(a)).

The distance 2γ0 between the intensity maxima is measured as a function of the frequency of the sinusoidal signal and the resonance frequency is determined from the amplitude frequency curves, with an accuracy of ±1 Hz.

In order to test for linearity, an etched fiber of length 1=19.6 mm and diameter d=14 μm was oscillated using sound waves. In FIG. 4(a), a plot of the resonance frequency r as a function of the amplitude of oscillation 0 of the fiber tip is shown. The resonance frequency (r=40 Hz) is found to be independent of the amplitude within the tested range of 25.3-69.1 μm .

Resonant frequency data obtained with the theoretical expression for an ideal cantilever.

Use of expression mentioned in L. Landau and L. Lifshitz, Theory of Elasticity (Pergamon Press, Oxford,1986) for the smallest characteristic frequency of transverse oscillations of a rod clamped at one end with the other end free:

$$\frac{3.516}{{l}^{2}} \sqrt{\frac{EI}{ρs}}$$

Here I=πd4/64 is the area moment of inertia of the rod,

$$\begin{matrix}s = π d 2 / 4 is the cross \text{-} sectional area , \\ = 2.297 \times 103 kg \text{/} m 3 is the density of the glass fiber \\ ( measured by weighing pieces of fiber using a microbalance ) .\end{matrix}$$

The measured value ωmin=2π r=251.33 rad/s was substituted in Eq. (1), to obtain a Young's modulus of E=141.91 GPa.

The measured value of E is roughly double of the value (“about 73 GPa”) provided by the manufacturer.

The resonance frequency of oscillation depends on the length and diameter of the fiber in the form r d/l2.

In FIG. 4(b), we show this proportionality for a set of fibers with lengths in the range of 9.7-24.3 mm and diameter in the range of 6.5-124.5 μm. This agreement between the measured and the estimated values shows that the cantilever spring constant can be accurately estimated from a measurement of its length and diameter once the material is characterized, i.e., its Young's modulus is determined.

Calibration process used is simple as compared to complicated processes in similar devices like Section III.B(2) in N. Desprat et al in Review of Scientific instruments,77, 055111 (2006) which makes it a major advantage of this particular device.

5. Camera-based Detection

The pixel resolution of the CCD camera was calibrated using a microscope calibration scale with a least count of 10 μm (AX0001, OB-M, Olympus Corp., Japan). Here on, unless otherwise specified, inventors have used the 40×/0.5 objective.

At this magnification, the calibration factor was found to equal 0.194 μm per pixel. The image of a well-cut static fiber produces a nearly-Gaussian intensity profile on the camera. A Region of Interest (ROI) larger than the beam profile is chosen when recording the data.

The intensity-weighted centroid of the fiber in the image plane is then calculated as

$$\text{?} ≡ ( \text{?} ) where \text{?}$$

$$\text{?} \text{indicates text missing or illegible when filed}$$

and xi and yi are

the x and y positions of the ith pixel.

The background intensity can affect the calculated position. To avoid this, the background intensity value Ib (the average value along the edge of the ROI) was used as a cutoff by setting Ii=0 for Ii<Ib.

In order to estimate the noise in this detection method we imaged a “rigid” cantilever, i.e., a short segment of an unetched optical fiber with the tip stuck to an aluminum block.

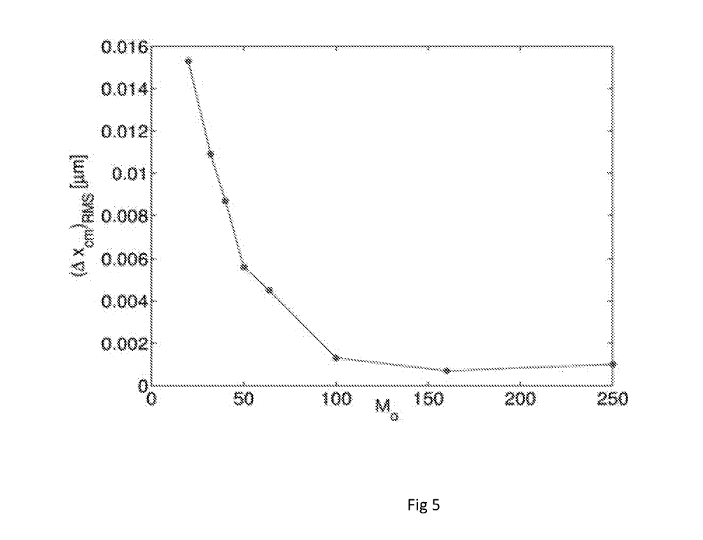

A drop of immersion oil (Immersol 518F, Carl Zeiss AG, Germany) was placed on a coverslip above the objective with the tip of the fiber dipping into it, to reduce scattering due to any imperfections in the cut. The position of the cantilever was recorded as a time series at 10 Hz for 300 s. The standard deviation for measured displacements of the x or y coordinate gives an estimate of the error in the detection method. A plot of (Δxcm)RMS as a function of the total magnification Mo is shown in FIG. 5. As can be seen from the plot, the best spatial resolution was obtained at Mo=250, with an error ˜1 nm.

6. Position-Sensitive Detector (PSD)

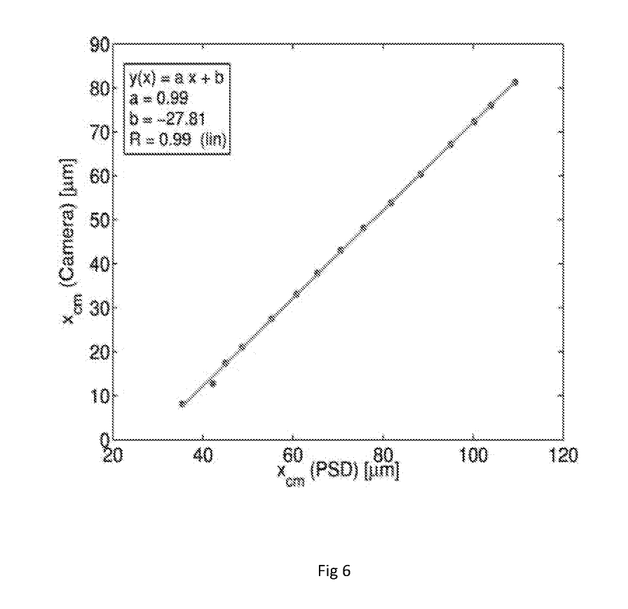

The resolution of the PSD, with a resistance length (inter-electrode distance) of 5700 μm and 12-bit resolution for the A/D conversion is 5700 μm/212=1.39 μm. When the light spot is imaged through a microscope, the resolution equals 1.39 μm/Mo (we use Mo=40). For checking the linear range of the PSD, an unetched fiber was mounted on the microscope using the translation stage. Position information was recorded using both the PSD software and the camera simultaneously for each displacement step made using the translation stage. In FIG. 6, the position of the centroid xcm coordinate tracked using the camera is plotted as a function of the PSD xcm coordinate and is found to be proportional. The position resolution was found to be independent of location within the active area of the PSD and the incident light level within the operating range.

7. Piezoelectric Transducer

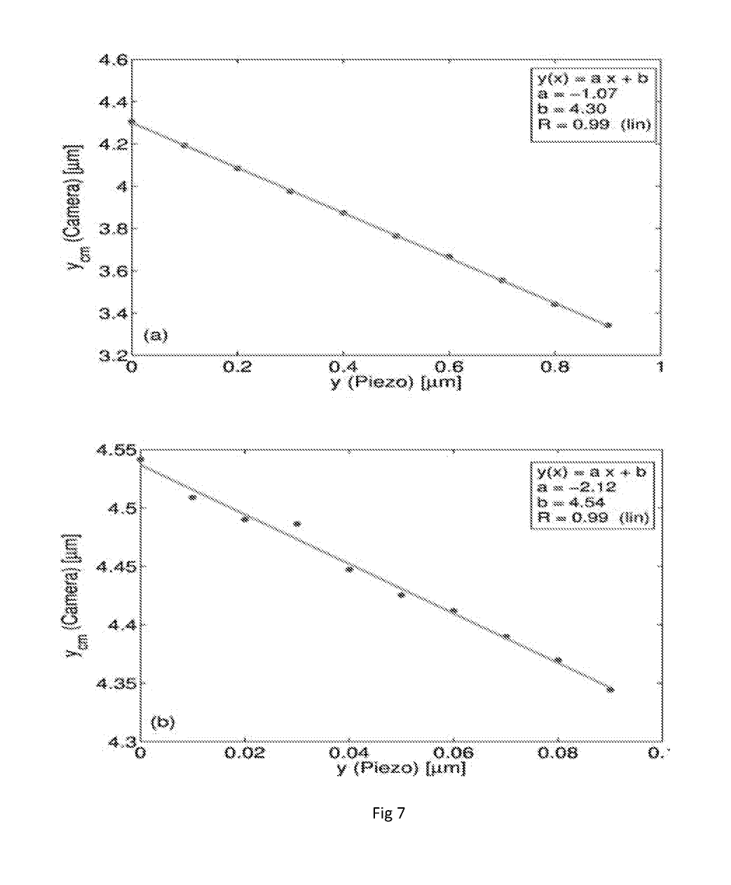

A carboxylate-modified fluorescent microsphere (Fluo-Spheres, Invitrogen Corp., USA) of 2 μm diameter was stuck to the tip of a 24 gauge injection needle which was magnetically attached to the piezo actuator and imaged using the camera. Images of the bead were recorded for step displacements of the piezo actuator. In FIG. 7(a), the centroid coordinate ycm of the spot as calculated from the camera images is plotted vis-a-vis the commanded piezo displacement in steps of 0.1 μm. In FIG. 7(b), ycm is plotted for piezo displacements with a step size 0.01 μm. The fit is found to be linear and the piezo actuator motion agrees with spot-tracking using the camera for displacements 0.01 μtm.

### NOVELTY OF THE INVENTION

The device of the present invention has several advanced features because of which it can be used singly for several applications viz:
The sample deformation (evolution) can be imaged simultaneously with rheological measurements.
Birefringence and fluorescence measurements are also possible. Map extensional stresses via particle-tracking of fluorescent beads or birefringence.
The device may be used to perform extension rheology of polymer melts, silk, or other bio-fluids at micro-scale, measure mechanical responses of living cells like muscle cells, neurons, etc. and biofluids such as blood, saliva, silkworm and spider silk, etc.
Extensional rheology of yield stress materials.
Oscillatory extensional rheometry.
It can also be used as a passive probe for microscale force measurements and to investigate properties of active suspensions like bacterial baths.
Use of optical-fiber cantilever as a force measuring device instead of microplates permits larger working range of force sensitivity (8 orders of magnitude).
Higher temporal resolution (˜10-6 s) using a Quadrant Photodiode.

Further applications will be clearly demonstrated with the help of the further examples. However it should be understood that the description of embodiments of the present invention has been prepared for purposes of illustration and description. It is not intended to be exhaustive or to limit the present invention to precise form disclosed, and modifications and variations are possible in light of the above teachings. The embodiments have been chosen to explain the principles of the present invention and should not be construed to be limitation in any form.

### EXAMPLES

The following examples are given by way of illustration of the working of the invention and therefore should not be construed to limit the scope of present invention

### 1. Experiments with a Bacterial Suspension

The dynamics of active matter is an important area of non-equilibrium statistical physics and bacterial suspensions have often been used as model systems. Typical experiments are performed by analyzing the response of latex beads trapped using an optical tweezer.

Inventors demonstrate below that a simpler system with only an etched optical fiber mounted on a translation stage above the microscope objective, with a camera (or QPD) for imaging, can be used for such studies.

For these experiments an etched fiber with a length 1=19.6 mm and a diameter d=11.2 μm, which has a spring constant k=1.78×10-4 N/m was used. The bacterial strain (RP5232) of Escherichia coli bacteria which are predominantly “swimmers,” was cultured in tryptone medium (Bacto Tryptone, BD Biosciences, USA) for about 6 h at 30 deg C. with shaking.

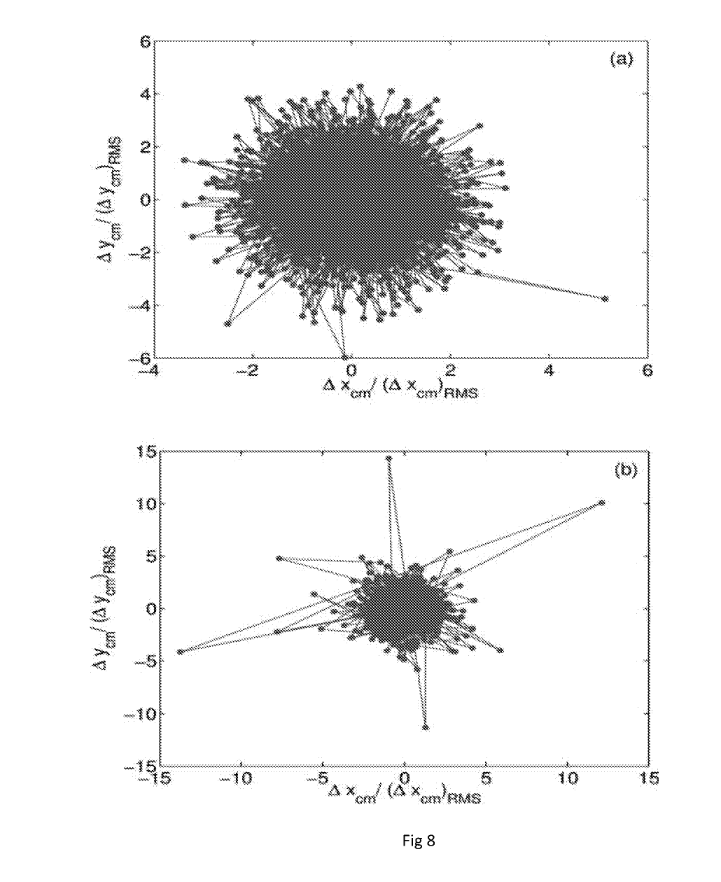

FIGS. 8(a) and 8(b), show plots of the centroid displacement components of the tip of the fiber normalized by their root-mean-square values, xcm/(xcm)RMS, ycm/(ycm)RMS for the medium alone and for the bacteria in the medium, recorded at 10 Hz for 300 s. The relatively larger forces exerted by the bacteria during random collisions with the fiber tip in FIG. 8(b). The kurtosis for x-displacements, K xcm≡<(xcm)4/(xcm)2>2 showed stark differences in magnitude, with K xcm=3.24 for the medium (for a stochastic variable x having a Gaussian distribution Kx=3) and K xcm=25.47 for the bacteria in the medium.

An estimate of the average magnitude of the force exerted on the cantilever was obtained by calculating the average magnitude of the displacement <|xcm|> for the two cases and multiplying with the spring constant, to get <|Fx|>=4.7×10-12 N for the bacteria in the medium and

<|Fx|>=2.23×10-12 N for the medium alone.

### 2. Extensional Rheology of Polymer Melts

In order to perform experiments in constant strain or constant force mode, a feedback-loop algorithm

is utilized in this device. The material is formed into a filament between a syringe needle attached to the piezo and the tip of the cantilever.

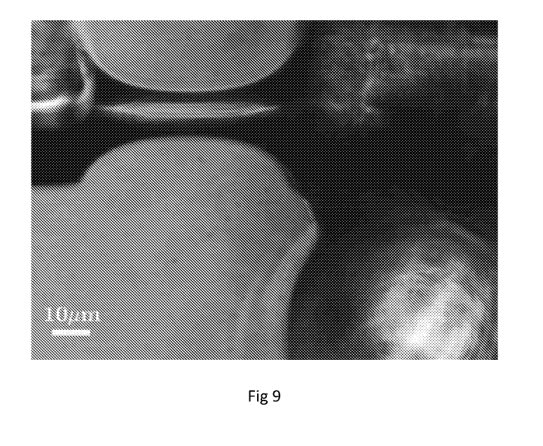

Mostly curved surfaces at the ends of the filament were used by the Inventors however, for a few experiments flat end-surfaces were constructed by gluing a short segment of the same optical fiber used for the cantilever to the syringe needle and to the tip of the cantilever, with about 1 mm projecting out of the needle. FIG. 9, we show a photograph of this arrangement.

In the constant force mode, the deflection of the cantilever is kept constant and the response strain and time varying cross-sectional area of the filament are monitored, while in the constant strain mode, the deflection of the cantilever and the cross-sectional area are monitored. One may also command an exponential strain to the piezo and use a high-speed camera to record the mid-plane diameter of the thinning filament, which may be used to infer the extensional viscosity of the material. Feedback-loop algorithm, was also validated with results from constant extension (or constant strain) experiments using polydimethylsiloxane (PDMS, Anton Paar GmbH, Austria), with a commanded extension of 10 μm.

The device of the present invention has several features in common with single molecule force spectroscopy devices such as AFM, optical tweezers, and magnetic tweezers but it overcomes the limitations of these devices. By doing so it combines the attributes of all such devices and offers one single device for several types of application.

Some common force-spectroscopy techniques have been compared with the device of this invention as in Table 1.

TABLE 1

| | Atomic | | | Device |
|---|---|---|---|---|
| | Force | Optical | Magnetic | of the |
| | Microscopes | Tweezers | Tweezers | Invention |
| Spatial resolution (nm) | 0.5-1 | 0.1-2 | 5-10 | ~1 |
| Temporal resolution (s) | 10⁻³ | 10⁻⁴ | 10⁻²-10⁻¹ | 10⁻⁶ |
| Force range (pN) | 10-10⁴ | 0.1-10² | 10⁻³-10² | 1-10⁸ |
| Displacement range | 0.5-10⁴ | 0.1-10⁵ | 5-10⁴ | 10-10⁵ |
| (nm) | | | | |

The data for (AFM, Optical and Magnetic tweezers) are taken from Neuman and A. Nagy, Nature Methods 5, 491 (2008).

### ADVANTAGES OF THE INVENTION

The main advantages of the invention are:

1. Measure the extensional viscosity of small quantities of samples, especially useful for biofluids, “tailor-made” model liquids, yield-stress materials and other complex fluids.

2. Measure the surface tension of the sample.

3. Extensional rheology under constant force and constant strain modes via a feedback loop.

4. Measure the force exerted by microscopic organisms and cells in their native environment.

5. Measure the extensional properties of model polymeric liquids of known architecture and use the results to test the validity of (theoretical) constitutive models for such materials, under extension.

6. Carry out high-speed imaging of the breakup of the thinning filament, especially useful for dilute samples.

7. Map out extensional stresses in the sample via birefringence or particle tracking.

8. Conduct studies of oscillatory extensional rheometry on viscoelastic materials, and compare the measured rheological properties with those obtained from oscillatory shear rheometry.

We claim:

1. Optical fiber based force transducer for microscale samples comprising:
a laser(1) which is placed above the objective of a microscope(5),a piezoelectric transducer(6) and an optical fiber (2) coupled to the said laser(1), cantilever(3) which is etched portion of the optical fiber senses force, a Position-Sensitive Detector (9) tracks the motion or deflection of the optical fiber cantilever(3), a lamp(13) within the microscope which illuminate the sample through a condenser(7) using green light, a camera(10) mounted on a side port of the microscope(5) which records image, filters(8) are placed in front of the camera(10) and the Position-Sensitive Detector (9) which separates the green illumination light and the red laser light, computer interface (14) records Position-Sensitive Detector (9) and piezoelectric control(11) reading, a custom-made software records and analyzes captured images in computer (14), sample(4) is placed between cantilever(3) and syringe needle(15), the said syringe needle(15) is connected to the piezoelectric transducer (6), linear polarizer and Fiber-optic connector (16) controls laser intensity and couples laser light to the said optical fiber (2), Quadrant Photodiode (QPD) mounted on a side port of the microscope, beam splitter(12) to split laser light.

2. A device as claimed in claim 1 wherein, Quadrant Photodiode (QPD) measures force in the range of 10⁻⁴N to 10⁻¹²N.

3. A device as claimed in claim 1 wherein, the said device obtains a temporal resolution in the range of 10⁻⁵ to 10⁻⁷s using a Quadrant Photodiode (QPD).

4. A device as claimed in claim 1 wherein, extension of the sample in the range of 10⁻⁸ m to 10⁻⁴ m is imposed with a spatial resolution in the range of 8 nm to 12 nm.

5. A device as claimed in claim 1 wherein, the said device allows independent control and measurement of the extensional strain or extensional force on a sample.

6. A device as claimed in claim 1 wherein, feedback-loop algorithm controls the extensional strain or extensional force on the sample.

7. A device as claimed in claim 1 wherein, operations are carried out in different modes like step-force, step-strain, or a specific force or strain protocol.

8. A device as claimed in claim 1 wherein, simultaneous video microscopy with sub-micron resolution is performed using phase-contrast, fluorescence or confocal modes of observation.

9. A device as claimed in claim 1 wherein, the rheological properties of samples are calculated for quantities in the range of 0.5 to 2 microlitres.

10. A device as claimed in claim 1 wherein, the said device maps extensional stresses within the sample, via birefringence.

11. A device as claimed in claim 1 wherein, samples includes living cells such as bacteria, muscle cells, neurons and biofluids such as blood, saliva, silkworm and spider silk.
